(19) United States
(12) Patent Application Publication
(10) Pub. No.: US 2024/0273016 A1
(43) Pub. Date: Aug. 15, 2024

(54) CLOSED-LOOP EQUALIZATION METHODS

(71) Applicant: Micron Technology, Inc., Boise, ID (US)

(72) Inventors: Michael L. Pook, Meridian, ID (US); Jonathan S. Parry, Boise, ID (US)

(21) Appl. No.: 18/439,673

(22) Filed: Feb. 12, 2024

Related U.S. Application Data
(60) Provisional application No. 63/484,733, filed on Feb. 13, 2023.

(51) Int. Cl. G06F 12/02

(52) U.S. Cl. CPC G06F 12/0246

(57) ABSTRACT

Methods, systems, and devices for closed-loop equalization methods are described. A memory device may receive, from a host device, a request to perform an equalization operation on a signal. The signal may include a pattern corresponding to the equalization operation. The memory device may receive the signal from the host device. The memory device may perform the equalization operation on the signal to determine one or more filter parameters for filtering the signal. The equalization operation may include filtering the signal and measuring one or more quality metrics for the filtered signal. The memory device may transmit, to the host device, an indication of the one or more quality metrics for the filtered signal. The memory device may determine whether the one or more filter parameters are stored at the memory device, the one or more filter parameters associated with a first mode corresponding to a first speed for communications.

### CROSS REFERENCE

The present Application for Patent claims the benefit of U.S. Provisional Patent Application No. 63/484,733 by POOK et al., entitled “CLOSED-LOOP EQUALIZATION METHODS,” filed Feb. 13, 2023, assigned to the assignee hereof, and expressly incorporated by reference herein.

### TECHNICAL FIELD

The following relates to one or more systems for memory, including closed-loop equalization methods.

### BACKGROUND

Memory devices are widely used to store information in devices such as computers, user devices, wireless communication devices, cameras, digital displays, and others. Information is stored by programming memory cells within a memory device to various states. For example, binary memory cells may be programmed to one of two supported states, often denoted by a logic 1 or a logic 0. In some examples, a single memory cell may support more than two states, any one of which may be stored. To access the stored information, the memory device may read (e.g., sense, detect, retrieve, determine) states from the memory cells. To store information, the memory device may write (e.g., program, set, assign) states to the memory cells.

Various types of memory devices exist, including magnetic hard disks, random access memory (RAM), read-only memory (ROM), dynamic RAM (DRAM), synchronous dynamic RAM (SDRAM), static RAM (SRAM), ferroelectric RAM (FeRAM), magnetic RAM (MRAM), resistive RAM (RRAM), flash memory, phase change memory (PCM), self-selecting memory, chalcogenide memory technologies, not-or (NOR) and not-and (NAND) memory devices, and others. Memory cells may be described in terms of volatile configurations or non-volatile configurations. Memory cells configured in a non-volatile configuration may maintain stored logic states for extended periods of time even in the absence of an external power source. Memory cells configured in a volatile configuration may lose stored states when disconnected from an external power source.

### BRIEF DESCRIPTION OF THE DRAWINGS

FIG. 1 illustrates an example of a system that supports closed-loop equalization methods in accordance with examples as disclosed herein.

FIG. 2 illustrates an example of a system that supports closed-loop equalization methods in accordance with examples as disclosed herein.

FIG. 3 illustrates an example of a process flow that supports closed-loop equalization methods in accordance with examples as disclosed herein.

FIG. 4 illustrates a block diagram of a memory system that supports closed-loop equalization methods in accordance with examples as disclosed herein.

FIG. 5 illustrates a block diagram of a host system that supports closed-loop equalization methods in accordance with examples as disclosed herein.

FIGS. 6 through 9 illustrate flowcharts showing a method or methods that support closed-loop equalization methods in accordance with examples as disclosed herein.

### DETAILED DESCRIPTION

Some devices (e.g., memory devices, host devices) may be capable of performing communications at various speeds (e.g., data rates), which may be referred to as gears. For example, a memory device and a host device may select or may otherwise be configured to communicate using any one of a quantity of gears (e.g., speeds). As described herein, a first set of gears (e.g., pulse width modulation (PWM) gears) may be utilized for relatively low speed communications and a second set of gears (e.g., high speed (HS) gears) may be utilized for relatively high speed communications. However, in some cases, increasing a speed for communications may lead to an increased occurrence of communication errors (e.g., bit errors). In some cases, a memory device may perform equalization operations (e.g., training operations, open-loop equalization operations) to tune (e.g., adjust) reception parameters (e.g., filter parameters), which may reduce communication errors and improve a received signal quality (e.g., as measured by an eye diagram). In some cases, equalization operations may be performed on a per channel (e.g., per lane) basis and may additionally be performed each time a speed change (e.g., a mode change) occurs. For example, equalization operations may be performed independently for each operating speed because each operating speed may correspond to a specific signaling type, and accordingly, to a specific prevalence of communication errors (e.g., bit errors). However, performing frequent equalization operations (e.g., for each speed change) that rely solely on receiver-based adjustments of filtering parameters (e.g., filtering adjustments made by a memory device coupled via a host-driven interface) may be inefficient and ineffective.

In accordance with examples as described herein, to improve efficiency and effectiveness of equalization operations, a memory device may transmit quality metrics (e.g., eye diagram metrics) to the host device, which may enable the host device to improve the quality of training signals. For example, the host device may receive the quality metrics from the memory device and adjust one or more transmission parameters (e.g., signal amplitude, pre-emphasis magnitude, de-emphasis magnitude) based on (e.g., in response to) the quality metrics. Additionally, or alternatively, filtering parameters and transmission parameters may be stored (e.g., by the memory device) for subsequent communications (e.g., at a specific speed), which may enable the memory device and the host device to refrain from performing equalization operations for each speed change and instead apply stored parameters (e.g., filtering parameters and transmission parameters) for communications performed at a given speed. In some cases, such equalization operations that incorporate signal quality feedback may be referred to as closed-loop equalization operations or closed-loop training operations. While some illustrative examples as described herein may refer to a memory device transmitting quality metrics to a host device for performing closed-loop equalization operations, such closed-loop equalization operations may also be performed by a host device. For example, a host device may transmit quality metrics to a memory device and the memory device may update transmission parameters (e.g., for the memory device) based on the received quality metrics.

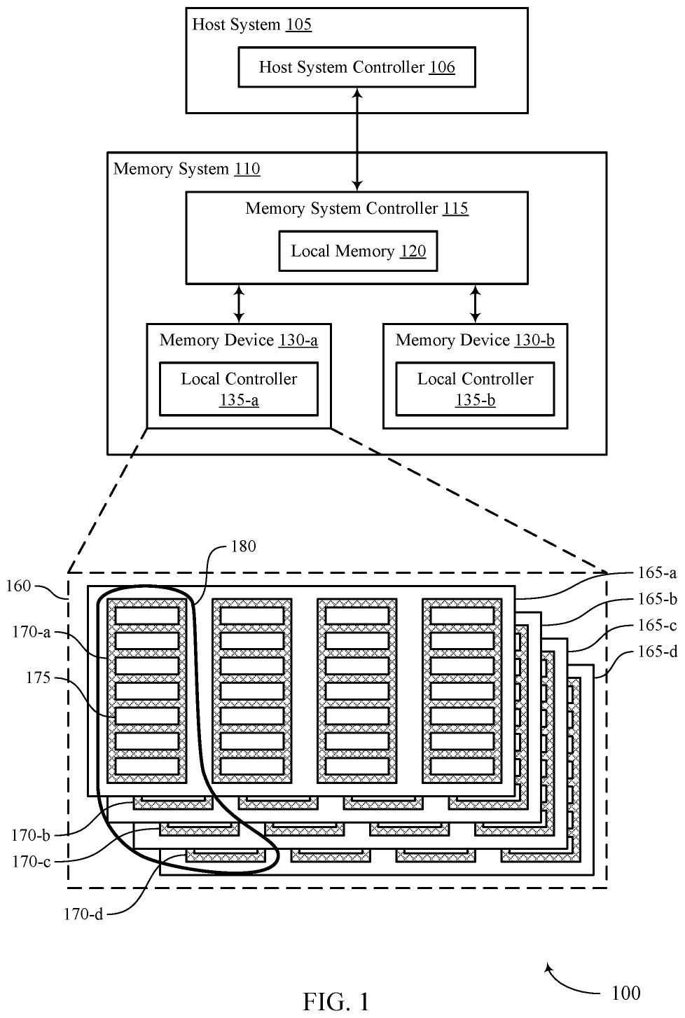

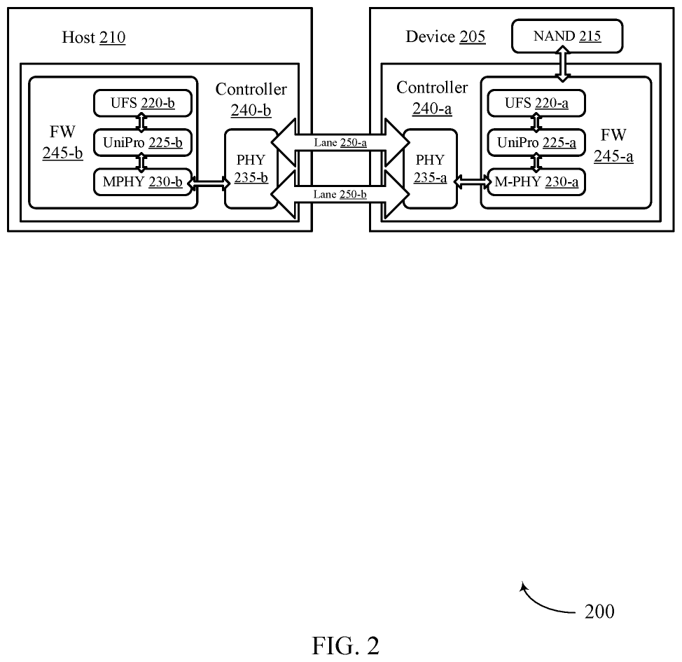

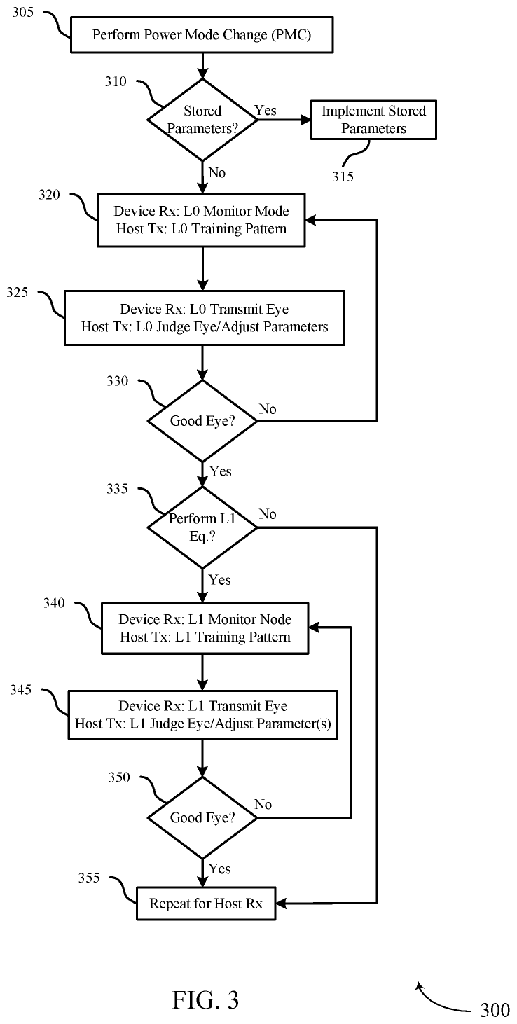

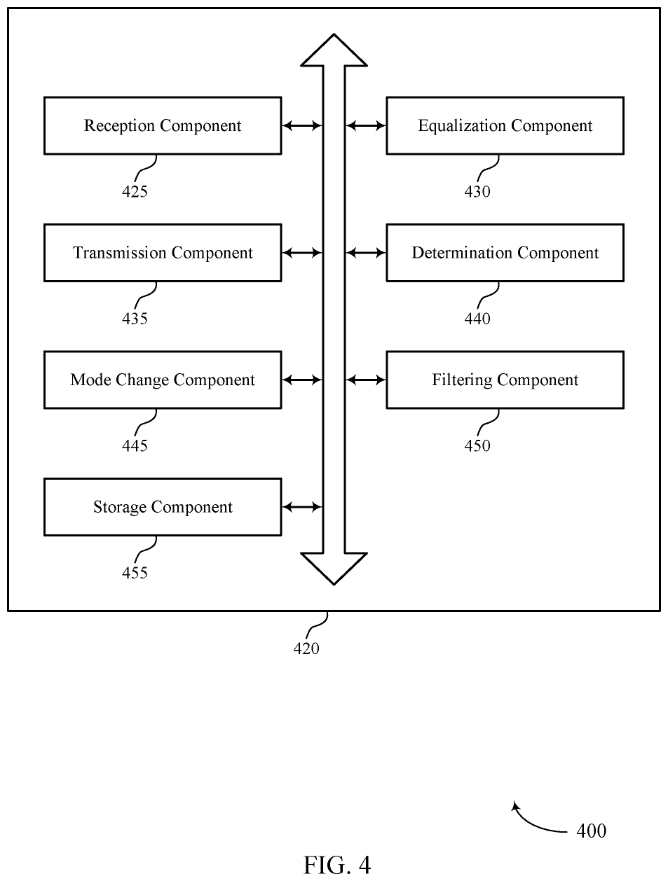

Features of the disclosure are initially described in the context of a system with reference to FIG. 1. Features of the disclosure are also described in the context of a system and a process flow with reference to FIGS. 2 and 3. These and other features of the disclosure are further illustrated by and described in the context of apparatus diagrams and flowcharts that relate to closed-loop equalization methods with reference to FIGS. 4 through 9.

FIG. 1 illustrates an example of a system 100 that supports closed-loop equalization methods in accordance with examples as disclosed herein. The system 100 includes a host system 105 coupled with a memory system 110.

A memory system 110 may be or include any device or collection of devices, where the device or collection of devices includes at least one memory array. For example, a memory system 110 may be or include a Universal Flash Storage (UFS) device, an embedded Multi-Media Controller (eMMC) device, a flash device, a universal serial bus (USB) flash device, a secure digital (SD) card, a solid-state drive (SSD), a hard disk drive (HDD), a dual in-line memory module (DIMM), a small outline DIMM (SO-DIMM), or a non-volatile DIMM (NVDIMM), among other possibilities.

The system 100 may be included in a computing device such as a desktop computer, a laptop computer, a network server, a mobile device, a vehicle (e.g., airplane, drone, train, automobile, or other conveyance), an Internet of Things (IoT) enabled device, an embedded computer (e.g., one included in a vehicle, industrial equipment, or a networked commercial device), or any other computing device that includes memory and a processing device.

The system 100 may include a host system 105, which may be coupled with the memory system 110. In some examples, this coupling may include an interface with a host system controller 106, which may be an example of a controller or control component configured to cause the host system 105 to perform various operations in accordance with examples as described herein. The host system 105 may include one or more devices and, in some cases, may include a processor chipset and a software stack executed by the processor chipset. For example, the host system 105 may include an application configured for communicating with the memory system 110 or a device therein. The processor chipset may include one or more cores, one or more caches (e.g., memory local to or included in the host system 105), a memory controller (e.g., NVDIMM controller), and a storage protocol controller (e.g., peripheral component interconnect express (PCIe) controller, universal flash storage (UFS) controller). The host system 105 may use the memory system 110, for example, to write data to the memory system 110 and read data from the memory system 110. Although one memory system 110 is shown in FIG. 1, the host system 105 may be coupled with any quantity of memory systems 110.

The host system 105 may be coupled with the memory system 110 via at least one physical host interface. The host system 105 and the memory system 110 may, in some cases, be configured to communicate via a physical host interface using an associated protocol (e.g., to exchange or otherwise communicate control, address, data, and other signals between the memory system 110 and the host system 105). Examples of a physical host interface may include, but are not limited to, an M-PHY interface. In some examples, one or more such interfaces may be included in or otherwise supported between a host system controller 106 of the host system 105 and a memory system controller 115 of the memory system 110. In some examples, the host system 105 may be coupled with the memory system 110 (e.g., the host system controller 106 may be coupled with the memory system controller 115) via a respective physical host interface for each memory device 130 included in the memory system 110, or via a respective physical host interface for each type of memory device 130 included in the memory system 110.

The memory system 110 may include a memory system controller 115 and one or more memory devices 130. A memory device 130 may include one or more memory arrays of any type of memory cells (e.g., non-volatile memory cells, volatile memory cells, or any combination thereof). Although two memory devices 130-a and 130-b are shown in the example of FIG. 1, the memory system 110 may include any quantity of memory devices 130. Further, if the memory system 110 includes more than one memory device 130, different memory devices 130 within the memory system 110 may include the same or different types of memory cells.

The memory system controller 115 may be coupled with and communicate with the host system 105 (e.g., via the physical host interface) and may be an example of a controller or control component configured to cause the memory system 110 to perform various operations in accordance with examples as described herein. The memory system controller 115 may also be coupled with and communicate with memory devices 130 to perform operations such as reading data, writing data, erasing data, or refreshing data at a memory device 130—among other such operations-which may generically be referred to as access operations. In some cases, the memory system controller 115 may receive commands from the host system 105 and communicate with one or more memory devices 130 to execute such commands (e.g., at memory arrays within the one or more memory devices 130). For example, the memory system controller 115 may receive commands or operations from the host system 105 and may convert the commands or operations into instructions or appropriate commands to achieve the desired access of the memory devices 130. In some cases, the memory system controller 115 may exchange data with the host system 105 and with one or more memory devices 130 (e.g., in response to or otherwise in association with commands from the host system 105). For example, the memory system controller 115 may convert responses (e.g., data packets or other signals) associated with the memory devices 130 into corresponding signals for the host system 105.

The memory system controller 115 may be configured for other operations associated with the memory devices 130. For example, the memory system controller 115 may execute or manage operations such as wear-leveling operations, garbage collection operations, error control operations such as error-detecting operations or error-correcting operations, encryption operations, caching operations, media management operations, background refresh, health monitoring, and address translations between logical addresses (e.g., logical block addresses (LBAs)) associated with commands from the host system 105 and physical addresses (e.g., physical block addresses) associated with memory cells within the memory devices 130.

The memory system controller 115 may include hardware such as one or more integrated circuits or discrete components, a buffer memory, or a combination thereof. The hardware may include circuitry with dedicated (e.g., hard-coded) logic to perform the operations ascribed herein to the memory system controller 115. The memory system controller 115 may be or include a microcontroller, special purpose logic circuitry (e.g., a field programmable gate array (FPGA), an application specific integrated circuit (ASIC), a digital signal processor (DSP)), or any other suitable processor or processing circuitry.

The memory system controller 115 may also include a local memory 120. In some cases, the local memory 120 may include read-only memory (ROM) or other memory that may store operating code (e.g., executable instructions) executable by the memory system controller 115 to perform functions ascribed herein to the memory system controller 115. In some cases, the local memory 120 may additionally, or alternatively, include static random access memory (SRAM) or other memory that may be used by the memory system controller 115 for internal storage or calculations, for example, related to the functions ascribed herein to the memory system controller 115. Additionally, or alternatively, the local memory 120 may serve as a cache for the memory system controller 115. For example, data may be stored in the local memory 120 if read from or written to a memory device 130, and the data may be available within the local memory 120 for subsequent retrieval for or manipulation (e.g., updating) by the host system 105 (e.g., with reduced latency relative to a memory device 130) in accordance with a cache policy.

Although the example of the memory system 110 in FIG. 1 has been illustrated as including the memory system controller 115, in some cases, a memory system 110 may not include a memory system controller 115. For example, the memory system 110 may additionally, or alternatively, rely on an external controller (e.g., implemented by the host system 105) or one or more local controllers 135, which may be internal to memory devices 130, respectively, to perform the functions ascribed herein to the memory system controller 115. In general, one or more functions ascribed herein to the memory system controller 115 may, in some cases, be performed instead by the host system 105, a local controller 135, or any combination thereof. In some cases, a memory device 130 that is managed at least in part by a memory system controller 115 may be referred to as a managed memory device. An example of a managed memory device is a managed NAND (MNAND) device.

A memory device 130 may include one or more arrays of non-volatile memory cells. For example, a memory device 130 may include NAND (e.g., NAND flash) memory, ROM, phase change memory (PCM), self-selecting memory, other chalcogenide-based memories, ferroelectric random access memory (RAM) (FeRAM), magneto RAM (MRAM), NOR (e.g., NOR flash) memory, Spin Transfer Torque (STT)-MRAM, conductive bridging RAM (CBRAM), resistive random access memory (RRAM), oxide based RRAM (OxRAM), electrically erasable programmable ROM (EEPROM), or any combination thereof. Additionally, or alternatively, a memory device 130 may include one or more arrays of volatile memory cells. For example, a memory device 130 may include RAM memory cells, such as dynamic RAM (DRAM) memory cells and synchronous DRAM (SDRAM) memory cells.

In some examples, a memory device 130 may include (e.g., on a same die or within a same package) a local controller 135, which may execute operations on one or more memory cells of the respective memory device 130. A local controller 135 may operate in conjunction with a memory system controller 115 or may perform one or more functions ascribed herein to the memory system controller 115. For example, as illustrated in FIG. 1, a memory device 130-a may include a local controller 135-a and a memory device 130-b may include a local controller 135-b.

In some cases, a memory device 130 may be or include a NAND device (e.g., NAND flash device). A memory device 130 may be or include a die 160 (e.g., a memory die). For example, in some cases, a memory device 130 may be a package that includes one or more dies 160. A die 160 may, in some examples, be a piece of electronics-grade semiconductor cut from a wafer (e.g., a silicon die cut from a silicon wafer). Each die 160 may include one or more planes 165, and each plane 165 may include a respective set of blocks 170, where each block 170 may include a respective set of pages 175, and each page 175 may include a set of memory cells.

In some cases, a NAND memory device 130 may include memory cells configured to each store one bit of information, which may be referred to as single level cells (SLCs). Additionally, or alternatively, a NAND memory device 130 may include memory cells configured to each store multiple bits of information, which may be referred to as multi-level cells (MLCs) if configured to each store two bits of information, as tri-level cells (TLCs) if configured to each store three bits of information, as quad-level cells (QLCs) if configured to each store four bits of information, or more generically as multiple-level memory cells. Multiple-level memory cells may provide greater density of storage relative to SLC memory cells but may, in some cases, involve narrower read or write margins or greater complexities for supporting circuitry.

In some cases, planes 165 may refer to groups of blocks 170, and in some cases, concurrent operations may be performed on different planes 165. For example, concurrent operations may be performed on memory cells within different blocks 170 so long as the different blocks 170 are in different planes 165. In some cases, an individual block 170 may be referred to as a physical block, and a virtual block 180 may refer to a group of blocks 170 within which concurrent operations may occur. For example, concurrent operations may be performed on blocks 170-a, 170-b, 170-c, and 170-d that are within planes 165-a, 165-b, 165-c, and 165-d, respectively, and blocks 170-a, 170-b, 170-c, and 170-d may be collectively referred to as a virtual block 180. In some cases, a virtual block may include blocks 170 from different memory devices 130 (e.g., including blocks in one or more planes of memory device 130-a and memory device 130-b). In some cases, the blocks 170 within a virtual block may have the same block address within their respective planes 165 (e.g., block 170-a may be “block 0” of plane 165-a, block 170-b may be “block 0” of plane 165-b, and so on). In some cases, performing concurrent operations in different planes 165 may be subject to one or more restrictions, such as concurrent operations being performed on memory cells within different pages 175 that have the same page address within their respective planes 165 (e.g., related to command decoding, page address decoding circuitry, or other circuitry being shared across planes 165).

In some cases, a block 170 may include memory cells organized into rows (pages 175) and columns (e.g., strings, not shown). For example, memory cells in a same page 175 may share (e.g., be coupled with) a common word line, and memory cells in a same string may share (e.g., be coupled with) a common digit line (which may alternatively be referred to as a bit line).

For some NAND architectures, memory cells may be read and programmed (e.g., written) at a first level of granularity (e.g., at the page level of granularity) but may be erased at a second level of granularity (e.g., at the block level of granularity). That is, a page 175 may be the smallest unit of memory (e.g., set of memory cells) that may be independently programmed or read (e.g., programed or read concurrently as part of a single program or read operation), and a block 170 may be the smallest unit of memory (e.g., set of memory cells) that may be independently erased (e.g., erased concurrently as part of a single erase operation). Further, in some cases, NAND memory cells may be erased before they can be re-written with new data. Thus, for example, a used page 175 may, in some cases, not be updated until the entire block 170 that includes the page 175 has been erased.

In some cases, a memory system 110 may utilize a memory system controller 115 to provide a managed memory system that may include, for example, one or more memory arrays and related circuitry combined with a local (e.g., on-die or in-package) controller (e.g., local controller 135). An example of a managed memory system is a managed NAND (MNAND) system.

The system 100 may include any quantity of non-transitory computer readable media that support closed-loop equalization methods. For example, the host system 105 (e.g., a host system controller 106), the memory system 110 (e.g., a memory system controller 115), or a memory device 130 (e.g., a local controller 135) may include or otherwise may access one or more non-transitory computer readable media storing instructions (e.g., firmware, logic, code) for performing the functions ascribed herein to the host system 105, the memory system 110, or a memory device 130. For example, such instructions, if executed by the host system 105 (e.g., by a host system controller 106), by the memory system 110 (e.g., by a memory system controller 115), or by a memory device 130 (e.g., by a local controller 135), may cause the host system 105, the memory system 110, or the memory device 130 to perform associated functions as described herein.

In accordance with examples as described herein, to improve efficiency and effectiveness of equalization operations, a memory system 110 (e.g., a memory device 130-a, a local controller 135-a, a memory system controller 115) may transmit quality metrics (e.g., eye diagram metrics) to a host system 105 (e.g., a host system controller 106) (e.g., as part of an equalization operation), which may enable the host system 105 to improve the quality of training signals. For example, the host system 105 may receive the quality metrics from the memory system 110 and adjust one or more transmission parameters (e.g., signal amplitude, pre-emphasis magnitude, de-emphasis magnitude) based on the quality metrics. Additionally, or alternatively, filtering parameters and transmission parameters may be stored (e.g., by the memory system 110, by the host system 105) for subsequent communications (e.g., subsequent filtering operations), which may enable the memory system 110 and the host system 105 to refrain from performing equalization operations for each speed change and instead apply stored parameters (e.g., filtering parameters and transmission parameters) for communications performed at a given speed. In some cases, such equalization operations that incorporate signal quality feedback may be referred to as closed-loop equalization operations or closed-loop training operations. While some illustrative examples as described herein may refer to a memory system 110 transmitting quality metrics to a host system 105 for performing closed-loop equalization operations, such closed-loop equalization operations may also be performed by a host system 105. For example, a host system 105 may transmit quality metrics to a memory system 110 and the memory system 110 may update transmission parameters based on the received quality metrics.

FIG. 2 illustrates an example of a system 200 that supports closed-loop equalization methods in accordance with examples as disclosed herein. The system 200 may be an example of a system 100, as described with reference to FIG. 1. For example, the system 200 may include a device 205, which may be an example of a memory system 110 or one or more aspects of a memory system 110 (e.g., a memory device 130), as described with reference to FIG. 1. Additionally, or alternatively, the system 200 may include a host 210, which may be an example of a host system 105 or one or more aspects of the host system 105, as described with reference to FIG. 1. As described herein, the host 210 may communicate with the device 205 via one or more lanes 250, which may be examples of couplings (e.g., electrical couplings, channels).

The device 205 may be an example of a UFS device or any other type of memory system 110. The device 205 may include one or more components, which may perform various functions associated with the device 205. For example, each component of the device 205 may include circuitry configured to perform one or more operations associated with the device 205. For example, the device 205 may include one or more components for storing information, such a NAND memory component 215. In some cases, the device 205 may store information using one or more memory cells of the NAND memory component 215. The device 205 may also include a controller 240-a. The controller 240-a may perform one or more operations associated with the device 205. In some cases, the controller 240-a may include or may otherwise be coupled with one or more other components of the device 205. For example, the controller 240-a may include firmware 245-a, which may perform logical operations associated with the device 205.

In some cases, the firmware 245-a may include or may otherwise be coupled with a UFS component 220-a, a unified protocol (UniPro) component 225-a, a multi-lane physical layer (M-PHY) component 230-a, and a physical layer (PHY) component 235-a. The UFS component 220-a may be an example of a storage component. For example, the device 205 may store information at the UFS component 220-a. The UniPro component 225-a, the M-PHY component 230-a, and the PHY component 235-a may each include circuitry configured to implement one or more functions of the device 205. Additionally, or alternatively, each component of the device 205 may be utilized for communicating information. For example, the device 205 may receive information (e.g., from the host 210) via the PHY component 235-a. The information may be transmitted from the PHY component 235-a to the M-PHY component 230-a, from the M-PHY component 230-a to the UniPro component 225-a, from the UniPro component 225-a to the UFS component 220-a, and from the UFS component 220-a to the NAND memory component 215.

The host 210 may include one or more components, which may perform various functions associated with the host 210. For example, each component of the host 210 may include circuitry configured to perform one or more operations associated with the host 210. For example, the host 210 may include a controller 240-b. The controller 240-b may perform one or more operations associated with the host 210. In some cases, the controller 240-b may include or may otherwise be coupled with one or more other components of the host 210. For example, the controller 240-b may include firmware 245-b, which may perform logical operations associated with the host 210.

In some cases, the firmware 245-b may include or may otherwise be coupled with a UFS component 220-b, a UniPro component 225-b, an M-PHY component 230-b, and a PHY component 235-b. The UFS component 220-b may be an example of a storage component. For example, the host 210 may store information at the UFS component 220-b. The UniPro component 225-b, the M-PHY component 230-b, and the PHY component 235-b may each include circuitry configured to implement one or more functions of the host 210. Additionally, or alternatively, each component of the host 210 may be utilized for communicating information. For example, the host 210 may receive information (e.g., from the device 205) via the PHY component 235-b. The information may be transmitted from the PHY component 235-b to the M-PHY component 230-b, from the M-PHY component 230-b to the UniPro component 225-b, and from the UniPro component 225-b to the UFS component 220-b.

The device 205 and the host 210 may communicate via one or more lanes 250. For example, the device 205 may transmit information to the host 210 via a lane 250-a, a lane 250-b, or both. Additionally, or alternatively, the host 210 may transmit information to the device 205 via the lane 250-a, the lane 250-b, or both. In some cases, each lane 250 may be utilized for bidirectional communications. For example, the device 205 may transmit and receive information via a lane 250. In some cases, each lane 250 may include one or more subchannels. For example, the lane 250-a may include a first subchannel for communications transmitted in a first direction (e.g., from the device 205 to the host 210) and a second subchannel for communications transmitted in a second direction (e.g., from the host 210 to the device 205).

The device 205 and the host 210 may be configured to perform communications at various speeds of a set of speeds (e.g., using various gears). For example, the host 210 may determine a speed for each of the lanes 250, and may signal to the device 205 what speed is used for each of the lanes 250. Device 205 may communicate with the host 210 over the lanes 250 using the indicated speeds. The host 210 may increase the gear (e.g., switch a lane 250 to a higher gear), or may decrease the gear (e.g., switch the lane to a lower gear), depending on an amount of traffic and support for the set of speeds by the device 205. The set of speeds may include a subset of PWM gears (e.g., PWM gear 1, PWM gear 2, and so on) and a subset of high speed gears (e.g., HSG 1, HSG 2, and so on). A PWM gear may, for example, use pulse-width modulation including two sub-phases to convey each bit of information, where the relative lengths of each sub-phase may convey the state of each bit. The high speed gears may use a synchronous shared clock, which may be embedded in each lane 250. Each change in high speed gears may involve a doubling of the speed. For example, HSG 2 may be twice as fast as HSG 1 and HSG 3 may be four times faster than HSG 1. Some gears may use non-return-to zero (NRZ) signaling (e.g., HSG 1, HSG 2, HSG 3, HSG 4, HSG 5), while others (e.g., HSG 6) may use multi-level signaling (e.g., PAM4). Additionally, or alternatively, the subset of PWM gears may be for lower speed communications when compared to the subset of high speed gears. In some cases, increasing a speed for communications may lead to an increased occurrence of communication errors (e.g., bit errors).

In some cases, the host 210, the device 205, or both may perform equalization operations (e.g., training operations, training sequences, open-loop equalization operations) to tune (e.g., adjust) reception parameters (e.g., filter parameters at the device 205), which may reduce communication errors. In some cases, equalization operations may be performed independently for each lane 250 and may additionally be performed each time a speed change (e.g., a power mode change (PMC)) occurs. As an illustrative example, an open-loop equalization operation, referred to as “ADAPT” may be utilized to tune, at a receiver (e.g., of the device 205) one or more continuous time linear equalization (CTLE) parameters, one or more decision feedback equalizer (DFE) parameters, or any combination thereof. However, such an open-loop equalization operation may not include tuning both reception (e.g., receiver) and transmission (e.g., transmitter) parameters. For example, the device 205 may perform an open-loop equalization operation (e.g., ADAPT) by adjusting CTLE parameters, DFE parameters, or both, in response to determining one or more quality metrics for a signal received from the host 210. However, such an open-loop equalization operations may not include any modification or adjustment of signal transmission parameters by the host 210. Additionally, or alternatively, adjusting CTLE and DFE parameters may provide limited improvements to signal quality and performing such open-loop equalization operations for each speed change (e.g., each PMC) may consume processing resources.

In accordance with examples as described herein, the device 205 and the host 210 may perform bidirectional communications on each lane 250 to perform a closed-loop equalization operation (e.g., to tune both receiver and transmission parameters in order to reduce communication errors for high speed communications). For example, the device 205 and the host 210 may perform a PMC into a relatively slow high speed gear, which may not use equalization (e.g., HSG1, HSG2, HSG3). Performing the PMC into the high speed gear (e.g., shifting from a PWM gear into HSG1) may improve an operating speed (e.g., reduce a duration) for performing the closed-loop equalization operation by implementing a highest speed (e.g., a highest equalization-free speed) to provide feedback to the transmitter. For example, the host 210 and the device 205 may communicate a portion of signaling for the closed-loop equalization operation (e.g., control signaling) using a first speed (e.g., HSG3 or lower) and may communicate another portion of signaling for the closed-loop equalization operation (e.g., training signals) using a second speed (e.g., HSG 4 or higher).

The host 210 may transmit, to the device 205, a flag (e.g., an indication) to request that closed-loop equalization be performed. The device 205 may confirm that the flag (e.g., the indication, the request) is received. In some cases, the device 205 may transmit a set of recommended starting parameters to the host 210 (e.g., parameters for the host 210 transmitter). Additionally, or alternatively, the device 205 may engage one or more receiving components (e.g., an eye monitor on its receiver) and may monitor for a training pattern to be transmitted by the host 210. The host 210 may then initiate a PMC (e.g., a second PMC) to higher speed communication (e.g., HSG5, HSG6, or higher) on the lane 250-a. In some cases, the PMC may be initiated (e.g., by the host 210) prior to transmitting the flag to the device 205 or subsequent to transmitting the flag to the device 205. For example, the device 205 and the host 210 may select any one of a set of operating speeds and lanes 250 for communicating the flag, the indication that the flag is received, and the recommended starting parameters.

The device 205 may receive signaling (e.g., a pattern, a training pattern) from the host 210 for performing the closed-loop equalization operation for a receiver of the device 205. As described herein, the device 205 may measure one or more quality metrics for the received signal. For example, the device may measure or otherwise determine an eye diagram for the received signal. In response to measuring the one or more quality metrics, the device 205 may adjust one or more parameters (e.g., reception parameters, CTLE, DFE). Additionally, or alternatively, the device 205 may report the eye parameters (e.g., the one or more quality metrics) to the host 210

In some cases, the device 205 may transmit a report (e.g., an indication of information) indicating the eye parameters to the host 210 using the lane 250-b (e.g., using the first speed, using HSG3). For example, the reported quality metrics may include one or more of eye amplitude, eye crossing percentage, eye crossing amplitude, signal-to-noise ratio (SNR), jitter (e.g., root mean square (RMS) jitter, peak-to-peak jitter), rise time, fall time, eye width, or duty cycle distortion. The report may also include one or more recommendations for tuning a transmitter of the host 210 (e.g., deemphasis magnitude, pre-emphasis magnitude, duty cycle correction, signal amplitude). For example, the device 205 may transmit one or both of eye parameters (e.g., the one or more quality metrics) and one or more transmission parameters (e.g., deemphasis magnitude, pre-emphasis magnitude, duty cycle correction, signal amplitude) to the host 210. Additionally, or alternatively, the device 205 may transmit the report on the lane 250-a (e.g., using the first speed, using HSG3). The host 210 may then adjust one or more transmission parameters based on the report (e.g., in response to information included in the report) and re-transmit the signal (e.g., the training pattern). The process may be repeated until the host 210 determines that the eye at the device receiver is satisfactory (e.g., that the one or more quality metrics satisfy one or more quality thresholds) or that a satisfactory eye for communications (e.g., communications using HSG4 or higher) cannot be achieved. If a satisfactory eye cannot be achieved, the PMC may be rejected (e.g., the device 205 and the host 210 would not perform the PMC or would otherwise revert back to a slower speed), and the host 210 would confirm the end of the closed-loop equalization operation. For example, the host 210 may transmit, to the device 205, an indication that the closed-loop equalization operation is complete.

Upon completion of the closed-loop equalization operation for the lane 250-a, the closed-loop equalization operation may be repeated for the lane 250-b. In some cases, the closed-loop equalization operation may begin with the same parameters used for the lane 250-a (e.g., the same reception parameters and the same transmission parameters). The host 210 may, however, determine to set a flag (e.g., store information) indicating that communications on the lane 250-b may be performed utilizing parameters values determined for the lane 250-a and may forego a separate closed-loop equalization operation for the lane 250-b. Once the host 210 transmitter and device 205 receiver training is complete, the same process may be repeated for the device 205 transmitter and the host 210 receiver. In some cases, final settings (e.g., tuned parameters) may be stored in non-volatile memory (e.g., the NAND memory component 215) for future use, which may negate the need for repeating the closed-loop equalization operation unless errors are subsequently detected.

FIG. 3 illustrates an example of a process flow 300 that supports closed-loop equalization methods in accordance with examples as disclosed herein. In some cases, one or more aspects of the process flow 300 may be implemented by one or more aspects of the system 100, as described with reference to FIG. 1. Additionally, or alternatively, one or more aspects of the process flow 300 may be implemented by one or more aspects of the system 200, as described with reference to FIG. 2. For example, a memory system 110, a memory system controller 115, a memory device 130, or a local controller 135, as described with reference to FIG. 1, may implement one or more aspects of the process flow 300. Additionally, or alternatively, a device 205, a host 210, a controller 240, or any other aspect (e.g., component) of the system 200, as described with reference to FIG. 2, may implement one or more aspects of the process flow 300.

Aspects of the process flow 300 may be implemented by a controller, among other components. Additionally, or alternatively, aspects of the process flow 300 may be implemented as instructions stored in memory (e.g., firmware stored in a memory coupled with a device 205 or a host 210). For example, the instructions, if executed by a controller (e.g., the memory system controller 115, a controller 240), may cause the controller to perform the operations of the process flow 300. In the following description of the process flow 300, the operations may occur in a different order than the order shown, or the operations may be performed at different times. Some operations may also be left out of process flow 300, or other operations may be added to process flow 300.

At 305, a PMC may be performed (e.g., by a device 205 and a host 210). For example, the device 205 and the host 210 may perform a PMC from a first gear (e.g., a PWM gear to a second gear (e.g., a high speed gear). As described herein, the second gear may be for higher speed communications than the first gear. In some cases, a closed-loop equalization process may not be performed for the first gear and may be performed for the second gear (e.g., based on a configuration or a table that indicates which gears equalization should be performed for). In some cases, the device 205 and the host 210 may perform a PMC from a PWM gear to HSG4 or higher, where the device 205 and the host 210 may perform a closed-loop equalization process in response to shifting into a gear greater than HSG3. In some cases, the PMC may be initiated by the host 210 or the controller 240-b. In some other cases, the PMC may be initiated by the device 205 or the controller 240-a.

At 310, an operation may be performed to determine if one or more parameters (e.g., parameter values, parameter settings) for the second speed (e.g., HSG4) are stored. For example, the device 205 may perform an operation, such as a read operation, to determine if one or more reception parameters are stored for the second speed. Additionally, or alternatively, the host 210 may perform an operation, such as a read operation, to determine if one or more transmission parameters are stored for the second speed. In some cases, the one or more parameters may have been stored during a previous closed-loop equalization operation. In some cases, the device 205 or any component of the device 205 may store the one or more parameters (e.g., from previous closed-loop equalization operations). In some other cases, the host 210 or any component of the host 210 may store the one or more parameters.

At 315, in response to determining that the one or more parameters are stored, the one or more parameters may be implemented. For example, the device 205 may implement the one or more parameters. That is, the device 205 may filter signaling received from the host 210 using the one or more parameters (e.g., the one or more filter parameters, one or more CTLE parameters, one or more DFE parameters). Additionally, or alternatively, the host 210 may implement the one or more parameters. That is, the host 210 may transmit signaling to the device 205 using the one or more parameters (e.g., signal amplitude, pre-emphasis magnitude, de-emphasis magnitude).

At 320, in response to determining that the one or more parameters are not stored, communications for the closed-loop equalization operation may be performed. For example, the device 205 may enter a monitoring mode and the host 210 may transmit a training pattern (e.g., a signal including a pattern) to the device 205. In some cases, entering the monitoring mode may include activating one or more receiving components (e.g., a receiver) of the device 205. In some cases, the communications for the closed-loop equalization operation may be performed using a first lane (e.g., the lane 250-a). Additionally, or alternatively, the communications may utilize one or more subchannels of the first lane. In some cases (e.g., at 320), one or more quality metrics may be determined. For example, the device 205 may measure one or more quality metrics for the received training pattern (e.g., the received signal including the pattern).

At 325, the one or more quality metrics may be transmitted and evaluated. For example, the device 205 may transmit the one or more quality metrics (e.g., an eye diagram, one or more metrics associated with an eye diagram) to the host 210. In some cases, the device 205 may indicate a pattern (e.g., second pattern) to be used for a subsequent iteration of transmission of a pattern by the transmitter and reception and measurement of quality metrics by the receiver. The host 210 may receive the one or more quality metrics and determine one or more parameters (e.g., transmission parameters) for improving a quality of communications. For example, the host 210 may update (e.g., adjust) a signal amplitude, a pre-emphasis magnitude, a de-emphasis magnitude for communications transmitted to the device 205, which may improve a received signal quality (e.g., one or more aspects of an eye diagram) at the device 205. In some cases, the one or more quality metrics may be transmitted to the host 210 using the first lane (e.g., the lane 250-a). In some other cases, the one or more quality metrics may be transmitted to the host 210 using the second lane (e.g., the lane 250-b). Additionally, or alternatively, the one or more parameters (e.g., transmission parameters) adjusted by the host 210 may be applied by the host 210 to the first lane (e.g., the lane 250-a). Additionally, or alternatively, the host 210 may transmit a signal (e.g., a second signal) to the device 205 using the updated one or more parameters. In some cases, the second signal may include the pattern (e.g., the training pattern, the training sequence). In some cases, the host 210 may update the pattern (e.g., in response to the one or more quality metrics, in response to the indication by the device 205 to use a second pattern).

At 330, the one or more quality metrics may be evaluated. For example, in response to receiving the second signal from the host 210, the device 205 may determine if the one or more quality metrics satisfy one or more quality thresholds. For example, the device 205 may determine if one or more aspects of an eye diagram (e.g., of the second signal) is acceptable. If the one or more quality metrics fail to satisfy the one or more quality thresholds, one or more previous steps may be repeated. For example, the device 205 may remeasure the one or more quality metrics, adjust one or more reception parameters, and may transmit an indication of the one or more quality metrics to the host 210. The host 210 may then adjust one or more transmission parameters and transmit a third signal (e.g., a third training signal) to the device 205. In some cases, the device 205, the host 210, or both, may be configured to refrain from performing a PMC if one or more quality thresholds are not satisfied. For example, after a quantity of attempts to satisfy the one or more quality thresholds, the device 205, the host 210, or both, may determine to refrain from performing the PMC (e.g., in response to a threshold quantity of failed attempts being satisfied).

At 335, a determination of whether the closed-loop equalization operation should be performed for the second lane (e.g., lane 250-b) may be made. For example, the device 205 or the host 210 may determine if the closed-loop equalization operation should be performed for the second lane (e.g., lane 250-b). In some cases, the device 205 or the host 210 may store information that indicates whether one or more parameters associated with the first lane (e.g., the lane 250-a) should be applied to one or more other lanes. For example, the host 210 may store or transmit a flag indicating that separate training (e.g., equalization) should not be performed for the second lane and that one or more parameters (e.g., transmission parameters and reception parameters) for the first lane should be utilized for communications on the second lane or any other lane. If the device 205 or the host 210 determines not to perform the closed-loop equalization operation for the second lane, the closed-loop equalization operation may be repeated for training (e.g., adjusting, equalizing) reception parameters for the host 210 and transmission parameters for the device 205.

At 340, in response to determining that the closed-loop equalization operation should be performed for the second lane (e.g., lane 250-b), communications for the closed-loop equalization operation may be performed (e.g., for the second lane). For example, the device 205 may enter a monitoring mode and the host 210 may transmit a training pattern (e.g., a signal including a pattern) to the device 205. In some cases, entering the monitoring mode may include activating one or more receiving components (e.g., a receiver) of the device 205. In some cases, the communications for the closed-loop equalization operation may be performed using the second lane (e.g., the lane 250-b). Additionally, or alternatively, the communications may utilize one or more subchannels of the second lane. In some cases (e.g., at 340), one or more quality metrics may be determined. For example, the device 205 may measure one or more quality metrics for the received training pattern (e.g., the received signal including the pattern).

At 345, the one or more quality metrics may be transmitted and evaluated. For example, the device 205 may transmit the one or more quality metrics (e.g., an eye diagram, one or more metrics associated with an eye diagram) to the host 210. The host 210 may receive the one or more quality metrics and determine one or more parameters (e.g., transmission parameters) for improving a quality of communications. For example, the host 210 may update (e.g., adjust) a signal amplitude, a pre-emphasis magnitude, a de-emphasis magnitude for communications transmitted to the device 205, which may improve a received signal quality (e.g., one or more aspects of an eye diagram) at the device 205. In some cases, the one or more quality metrics may be transmitted to the host 210 using the first lane (e.g., the lane 250-a). In some other cases, the one or more quality metrics may be transmitted to the host 210 using the second lane (e.g., the lane 250-b). Additionally, or alternatively, the one or more parameters (e.g., transmission parameters) adjusted by the host 210 may be applied by the host 210 to the second lane (e.g., the lane 250-b). Additionally, or alternatively, the host 210 may transmit a signal (e.g., a second signal) to the device 205 using the updated one or more parameters. In some cases, the second signal may include the pattern (e.g., the training pattern, the training sequence). In some cases, the host 210 may update the pattern (e.g., in response to the one or more quality metrics).

At 350, the one or more quality metrics may be evaluated. For example, in response to receiving the second signal from the host 210, the device 205 may determine if the one or more quality metrics satisfy one or more quality thresholds. For example, the device 205 may determine if one or more aspects of an eye diagram (e.g., of the second signal) is acceptable. If the one or more quality metrics fail to satisfy the one or more quality thresholds, one or more previous steps may be repeated. For example, the device 205 may remeasure the one or more quality metrics, adjust one or more reception parameters, and may transmit an indication of the one or more quality metrics to the host 210. The host 210 may then adjust one or more transmission parameters and transmit a third signal (e.g., a third training signal) to the device 205.

At 355, the closed-loop equalization operation may be repeated as described herein for a transmitter of the device 205 and a receiver of the host 210. In some cases, device 205 may determine to repeat the closed-loop equalization operation in response to determining that one or more quality metrics for the second lane (e.g., the lane 250-b) satisfy one or more quality thresholds. Additionally, or alternatively, the host 210 may determine to repeat the closed-loop equalization operation in response to determining that the one or more quality metrics for the second lane (e.g., the lane 250-b) satisfy the one or more quality thresholds.

FIG. 4 illustrates a block diagram 400 of a memory system 420 that supports closed-loop equalization methods in accordance with examples as disclosed herein. The memory system 420 may be an example of aspects of a memory system as described with reference to FIGS. 1 through 3. The memory system 420, or various components thereof, may be an example of means for performing various aspects of closed-loop equalization methods as described herein. For example, the memory system 420 may include a reception component 425, an equalization component 430, a transmission component 435, a determination component 440, a mode change component 445, a filtering component 450, a storage component 455, or any combination thereof. Each of these components may communicate, directly or indirectly, with one another (e.g., via one or more buses).

The memory system 420 may support operating a memory device in accordance with examples as disclosed herein. The reception component 425 may be configured as or otherwise support a means for receiving, from a host device, a request (e.g., an indication) to perform an equalization operation on a signal, the signal including a pattern corresponding to the equalization operation. In some examples, the reception component 425 may be configured as or otherwise support a means for receiving, from the host device, the signal. The equalization component 430 may be configured as or otherwise support a means for performing the equalization operation on the signal to determine one or more filter parameters for filtering the signal, the equalization operation including filtering the signal and measuring one or more quality metrics for the filtered signal. The transmission component 435 may be configured as or otherwise support a means for transmitting, to the host device, an indication of the one or more quality metrics for the filtered signal.

In some examples, the determination component 440 may be configured as or otherwise support a means for determining whether the one or more filter parameters are stored at the memory device, the one or more filter parameters associated with a first mode corresponding to a first speed for communications, where the indication to perform the equalization operation on the signal is received based at least in part on the determining.

In some examples, the reception component 425 may be configured as or otherwise support a means for receiving, from the host device, a second signal including the pattern, where the second signal is based at least in part on the indication of the one or more quality metrics for the filtered signal.

In some examples, the reception component 425 may be configured as or otherwise support a means for receiving, from the host device, a second signal including a second pattern, where the second signal and the second pattern are based at least in part on the indication of the one or more quality metrics for the filtered signal.

In some examples, the reception component 425 may be configured as or otherwise support a means for receiving, from the host device, a second signal, where the second signal is based at least in part on the indication of the one or more quality metrics for the filtered signal. In some examples, the equalization component 430 may be configured as or otherwise support a means for performing the equalization operation on the second signal to obtain a filtered second signal. In some examples, the transmission component 435 may be configured as or otherwise support a means for transmitting, to the host device, an indication of one or more quality metrics for the filtered second signal.

In some examples, the reception component 425 may be configured as or otherwise support a means for receiving, from the host device, an indication that the equalization operation is complete based at least in part on the indication of the one or more quality metrics for the filtered signal.

In some examples, the storage component 455 may be configured as or otherwise support a means for storing the one or more filter parameters in the memory device, where the storing is based at least in part on receiving, from the host device, the indication that the equalization operation is complete for a first mode. In some examples, the mode change component 445 may be configured as or otherwise support a means for performing a mode change from the first mode to a second mode. In some examples, the mode change component 445 may be configured as or otherwise support a means for performing a mode change from the second mode to the first mode. In some examples, the filtering component 450 may be configured as or otherwise support a means for filtering one or more signals using the stored one or more filter parameters based at least in part on performing the mode change from the second mode to the first mode.

In some examples, the determination component 440 may be configured as or otherwise support a means for determining that the one or more quality metrics for the filtered signal fail to satisfy one or more thresholds for the one or more quality metrics, where transmitting, to the host device, the indication of the one or more quality metrics for the filtered signal is based at least in part on the filtered signal failing to satisfy the one or more thresholds.

In some examples, the reception component 425 may be configured as or otherwise support a means for receiving, from the host device, a request to perform a second equalization operation on a second signal. In some examples, the reception component 425 may be configured as or otherwise support a means for receiving the second signal from the host device via a second channel. In some examples, the equalization component 430 may be configured as or otherwise support a means for performing the equalization operation on the second signal to obtain a filtered second signal. In some examples, the transmission component 435 may be configured as or otherwise support a means for transmitting, to the host device, an indication of one or more quality metrics for the filtered second signal.

In some examples, receiving the signal further includes receiving the signal via a first channel, the first channel including a first subchannel configured for receiving signaling from the host device and a second subchannel configured for transmitting signaling to the host device. In some examples, transmitting the indication of the one or more quality metrics further includes transmitting the indication of the one or more quality metrics via a second channel.

In some examples, receiving the signal further includes receiving the signal via a first channel, the first channel including a first subchannel configured for receiving signaling from the host device and a second subchannel configured for transmitting signaling to the host device. In some examples, transmitting the indication of the one or more quality metrics further includes transmitting the indication of the one or more quality metrics via the first channel.

In some examples, the mode change component 445 may be configured as or otherwise support a means for performing a mode change from a first mode to a second mode, the first mode corresponding to a first speed for communications, the second mode corresponding to a second speed for communications greater than the first speed, where the one or more filter parameters are for filtering communications at a third speed, the third speed greater than the second speed.

In some examples, the indication of the one or more quality metrics is transmitted, to the host device, using the second speed for communications and the signal is received, from the host device, using the third speed for communications.

In some examples, the indication to perform the equalization operation is received, from the host device, using the second speed for communications.

In some examples, the storage component 455 may be configured as or otherwise support a means for storing the one or more filter parameters in the memory device. In some examples, the mode change component 445 may be configured as or otherwise support a means for performing a mode change from the second mode to a third mode, the third mode corresponding to the third speed for communications. In some examples, the reception component 425 may be configured as or otherwise support a means for receiving one or more signals from the host device. In some examples, the filtering component 450 may be configured as or otherwise support a means for filtering the one or more signals using the stored one or more filter parameters based at least in part on performing the mode change from the second mode to the third mode.

In some examples, the equalization component 430 may be configured as or otherwise support a means for refraining from performing the equalization operation for subsequent mode changes into a third mode based at least in part on storing the one or more filter parameters.

In some examples, the transmission component 435 may be configured as or otherwise support a means for transmitting, to the host device, an indication of one or more parameters for the host device based at least in part on the one or more quality metrics for the filtered signal failing to satisfy a threshold, the one or more parameters including a deemphasis parameter for signaling transmitted by the host device, a pre-emphasis parameter for signaling transmitted by the host device, a duty cycle correction parameter for signaling transmitted by the host device, an amplitude parameter for signaling transmitted by the host device, or any combination thereof.

In some examples, to support performing the equalization operation, the filtering component 450 may be configured as or otherwise support a means for varying the one or more filter parameters for filtering the signal, where the varying is based at least in part on whether the one or more quality metrics for the filtered signal satisfy one or more thresholds. In some examples, one or more parameters for the signal are adjusted based at least in part on the one or more quality metrics for the filtered signal.

In some examples, the transmission component 435 may be configured as or otherwise support a means for transmitting, to the host device, a request to perform a second equalization operation on a second signal, the second signal including a second pattern corresponding to the second equalization operation. In some examples, the transmission component 435 may be configured as or otherwise support a means for transmitting, to the host device, the second signal. In some examples, the reception component 425 may be configured as or otherwise support a means for receiving, from the host device, an indication of one or more quality metrics for the second signal, the one or more quality metrics based at least in part on the host device filtering the second signal.

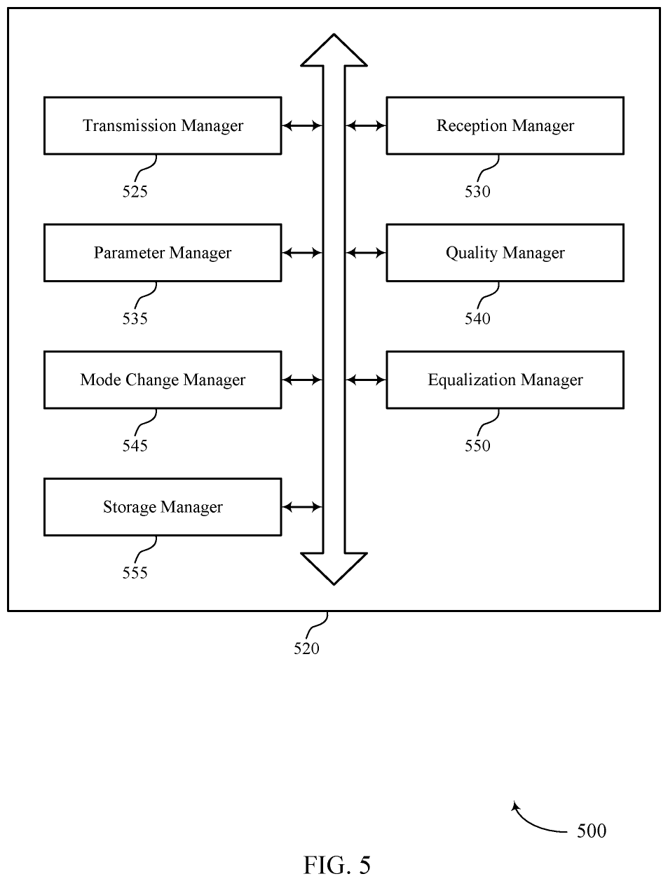

FIG. 5 illustrates a block diagram 500 of a host system 520 that supports closed-loop equalization methods in accordance with examples as disclosed herein. The host system 520 may be an example of aspects of a host system as described with reference to FIGS. 1 through 3. The host system 520, or various components thereof, may be an example of means for performing various aspects of closed-loop equalization methods as described herein. For example, the host system 520 may include a transmission manager 525, a reception manager 530, a parameter manager 535, a quality manager 540, a mode change manager 545, an equalization manager 550, a storage manager 555, or any combination thereof. Each of these components may communicate, directly or indirectly, with one another (e.g., via one or more buses).

The host system 520 may support operating a host device in accordance with examples as disclosed herein. The transmission manager 525 may be configured as or otherwise support a means for transmitting, to a memory device, a request to perform an equalization operation on a signal, the equalization operation including filtering the signal and measuring one or more quality metrics for the filtered signal. In some examples, the transmission manager 525 may be configured as or otherwise support a means for transmitting, to the memory device, the signal, where the signal includes a pattern corresponding to the equalization operation. The reception manager 530 may be configured as or otherwise support a means for receiving, from the memory device, an indication of the one or more quality metrics for the filtered signal.

In some examples, the parameter manager 535 may be configured as or otherwise support a means for adjusting, at the host device, one or more parameters for the signal based at least in part on the one or more quality metrics for the filtered signal. In some examples, one or more parameters for the signal are adjusted based at least in part on the one or more quality metrics for the filtered signal.

In some examples, the one or more parameters include a deemphasis parameter, a pre-emphasis parameter, a duty cycle correction parameter, an amplitude parameter, or any combination thereof.

In some examples, the transmission manager 525 may be configured as or otherwise support a means for transmitting, to the memory device, a second signal including the pattern, where one or more parameters for transmitting the second signal are based at least in part on the one or more quality metrics for the filtered signal.

In some examples, the transmission manager 525 may be configured as or otherwise support a means for transmitting, to the memory device, a second signal including a second pattern, where one or more parameters for transmitting the second signal and the second pattern are based at least in part on the one or more quality metrics for the filtered signal.

In some examples, the quality manager 540 may be configured as or otherwise support a means for determining that the one or more quality metrics for the filtered signal fail to satisfy one or more thresholds for the one or more quality metrics. In some examples, the transmission manager 525 may be configured as or otherwise support a means for transmitting, to the memory device, a second signal based at least in part on the determination.

In some examples, the reception manager 530 may be configured as or otherwise support a means for receiving, from the memory device, an indication of one or more quality metrics for the second signal.

In some examples, the transmission manager 525 may be configured as or otherwise support a means for transmitting, to the memory device, an indication that the equalization operation is complete for a first mode based at least in part on the one or more quality metrics for the filtered signal satisfying one or more thresholds for the one or more quality metrics.

In some examples, the storage manager 555 may be configured as or otherwise support a means for storing one or more parameters for transmitting signaling to the memory device based at least in part on transmitting the indication that the equalization operation is complete.

In some examples, the transmission manager 525 may be configured as or otherwise support a means for transmitting, to the memory device, a request to perform a mode change from a first mode to a second mode, the first mode corresponding to a first speed for communications, the second mode corresponding to a second speed for communications greater than the first speed. In some examples, the mode change manager 545 may be configured as or otherwise support a means for performing the mode change from the first mode to the second mode based at least in part on transmitting the indication to perform the mode change.

In some examples, the transmission manager 525 may be configured as or otherwise support a means for transmitting, to the memory device, a request to perform a second equalization operation on a second signal. In some examples, the transmission manager 525 may be configured as or otherwise support a means for transmitting the second signal to the memory device via a second channel. In some examples, the reception manager 530 may be configured as or otherwise support a means for receiving, from the memory device, an indication of one or more quality metrics for the second signal filtered by the memory device.

In some examples, transmitting the signal further includes transmitting the signal via a first channel, the first channel including a first subchannel configured for transmitting signaling to the memory device and a second subchannel configured for receiving signaling from the memory device. In some examples, receiving the indication of the one or more quality metrics further includes receiving the indication of the one or more quality metrics via a second channel.

In some examples, transmitting the signal further includes transmitting the signal via a first channel, the first channel including a first subchannel configured for transmitting signaling to the memory device and a second subchannel configured for receiving signaling from the memory device. In some examples, receiving the indication of the one or more quality metrics further includes receiving the indication of the one or more quality metrics via the first channel.

In some examples, the mode change manager 545 may be configured as or otherwise support a means for performing a mode change from a first mode to a second mode, the first mode corresponding to a first speed for communications, the second mode corresponding to a second speed for communications greater than the first speed, where the equalization operation is for filtering signaling at a third speed, the third speed greater than the second speed.

In some examples, the indication of the one or more quality metrics is received, from the memory device, using the second speed for communications and the signal is transmitted, to the memory device, using the third speed for communications. In some examples, the quality manager 540 or another component may be configured or otherwise support a means to adjust a setting associated with the equalization operation, the setting including one or more parameters for the signal, based at least in part on the one or more quality metrics for the filtered signal.

In some examples, the indication to perform the equalization operation is transmitted, to the memory device, using the second speed for communications. In some examples, the transmission manager 525 may be configured as or otherwise support a means for refraining from transmitting the indication to perform the equalization operation for subsequent mode changes into a third mode.

In some examples, the reception manager 530 may be configured as or otherwise support a means for receiving, from the memory device, an indication of one or more parameters for the host device, the one or more parameters including a deemphasis parameter for signaling transmitted by the host device, a pre-emphasis parameter for signaling transmitted by the host device, a duty cycle correction parameter for signaling transmitted by the host device, an amplitude parameter for signaling transmitted by the host device, or any combination thereof.

In some examples, the reception manager 530 may be configured as or otherwise support a means for receiving, from the memory device, a request to perform a second equalization operation on a second signal, the second signal including a second pattern corresponding to the second equalization operation. In some examples, the reception manager 530 may be configured as or otherwise support a means for receiving, from the memory device, the second signal. In some examples, the equalization manager 550 may be configured as or otherwise support a means for performing the second equalization operation on the second signal to determine one or more filter parameters for filtering the second signal, the second equalization operation including filtering the second signal and measuring one or more second quality metrics for the filtered signal. In some examples, the transmission manager 525 may be configured as or otherwise support a means for transmitting, to the memory device, an indication of the one or more second quality metrics for the filtered second signal.

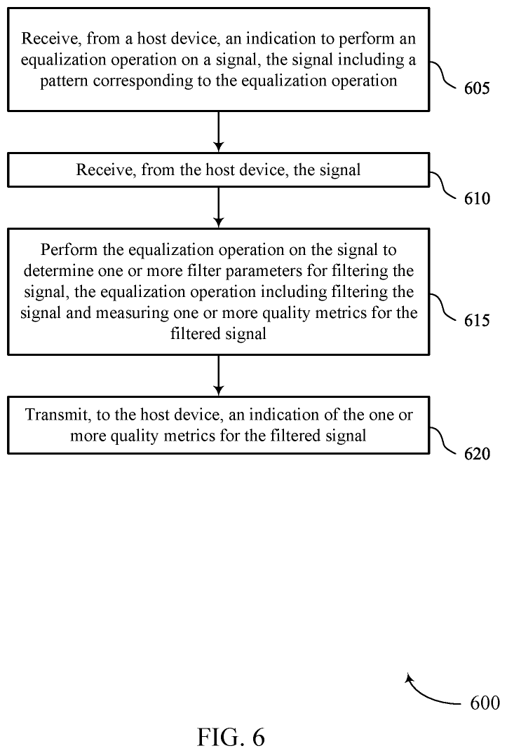

FIG. 6 illustrates a flowchart showing a method 600 that supports closed-loop equalization methods in accordance with examples as disclosed herein. The operations of method 600 may be implemented by a memory system or its components as described herein. For example, the operations of method 600 may be performed by a memory system as described with reference to FIGS. 1 through 4. In some examples, a memory system may execute a set of instructions to control the functional elements of the device to perform the described functions. Additionally, or alternatively, the memory system may perform aspects of the described functions using special-purpose hardware.

At 605, the method may include receiving, from a host device, a request to perform an equalization operation on a signal, the signal including a pattern corresponding to the equalization operation. The operations of 605 may be performed in accordance with examples as disclosed herein. In some examples, aspects of the operations of 605 may be performed by a reception component 425 as described with reference to FIG. 4.

At 610, the method may include receiving, from the host device, the signal. The operations of 610 may be performed in accordance with examples as disclosed herein. In some examples, aspects of the operations of 610 may be performed by a reception component 425 as described with reference to FIG. 4.

At 615, the method may include performing the equalization operation on the signal to determine one or more filter parameters for filtering the signal, the equalization operation including filtering the signal and measuring one or more quality metrics for the filtered signal. In some examples, one or more parameters for the signal may be adjusted based at least in part on the one or more quality metrics for the filtered signal. The operations of 615 may be performed in accordance with examples as disclosed herein. In some examples, aspects of the operations of 615 may be performed by an equalization component 430 as described with reference to FIG. 4.

At 620, the method may include transmitting, to the host device, an indication of the one or more quality metrics for the filtered signal. The operations of 620 may be performed in accordance with examples as disclosed herein. In some examples, aspects of the operations of 620 may be performed by a transmission component 435 as described with reference to FIG. 4.

In some examples, an apparatus as described herein may perform a method or methods, such as the method 600. The apparatus may include features, circuitry, logic, means, or instructions (e.g., a non-transitory computer-readable medium storing instructions executable by a processor), or any combination thereof for performing the following aspects of the present disclosure:
Aspect 1: A method, apparatus (e.g., a memory system, as described herein), or non-transitory computer-readable medium including operations, features, circuitry, logic, means, or instructions, or any combination thereof for receiving, from a host device, a request to perform an equalization operation on a signal, the signal including a pattern corresponding to the equalization operation; receiving, from the host device, the signal; performing the equalization operation on the signal to determine one or more filter parameters for filtering the signal, the equalization operation including filtering the signal and measuring one or more quality metrics for the filtered signal; and transmitting, to the host device, an indication of the one or more quality metrics for the filtered signal.
Aspect 2: The method, apparatus, or non-transitory computer-readable medium of aspect 1, further including operations, features, circuitry, logic, means, or instructions, or any combination thereof for determining whether the one or more filter parameters are stored at the memory device, the one or more filter parameters associated with a first mode corresponding to a first speed for communications, where the request to perform the equalization operation on the signal is received based at least in part on the determining.
Aspect 3: The method, apparatus, or non-transitory computer-readable medium of any of aspects 1 through 2, further including operations, features, circuitry, logic, means, or instructions, or any combination thereof for receiving, from the host device, a second signal including the pattern, where the second signal is based at least in part on the indication of the one or more quality metrics for the filtered signal.
Aspect 4: The method, apparatus, or non-transitory computer-readable medium of any of aspects 1 through 3, further including operations, features, circuitry, logic, means, or instructions, or any combination thereof for receiving, from the host device, a second signal including a second pattern, where the second signal and the second pattern are based at least in part on the indication of the one or more quality metrics for the filtered signal.
Aspect 5: The method, apparatus, or non-transitory computer-readable medium of any of aspects 1 through 4, further including operations, features, circuitry, logic, means, or instructions, or any combination thereof for receiving, from the host device, a second signal, where the second signal is based at least in part on the indication of the one or more quality metrics for the filtered signal; performing the equalization operation on the second signal to obtain a filtered second signal; and transmitting, to the host device, an indication of one or more quality metrics for the filtered second signal.
Aspect 6: The method, apparatus, or non-transitory computer-readable medium of any of aspects 1 through 5, further including operations, features, circuitry, logic, means, or instructions, or any combination thereof for receiving, from the host device, an indication that the equalization operation is complete based at least in part on the indication of the one or more quality metrics for the filtered signal.
Aspect 7: The method, apparatus, or non-transitory computer-readable medium of aspect 6, further including operations, features, circuitry, logic, means, or instructions, or any combination thereof for storing the one or more filter parameters in the memory device, where the storing is based at least in part on receiving, from the host device, the indication that the equalization operation is complete for a first mode; performing a mode change from the first mode to a second mode; performing a mode change from the second mode to the first mode; and filtering one or more signals using the stored one or more filter parameters based at least in part on performing the mode change from the second mode to the first mode.
Aspect 8: The method, apparatus, or non-transitory computer-readable medium of any of aspects 1 through 7, further including operations, features, circuitry, logic, means, or instructions, or any combination thereof for determining that the one or more quality metrics for the filtered signal fail to satisfy one or more thresholds for the one or more quality metrics, where transmitting, to the host device, the indication of the one or more quality metrics for the filtered signal is based at least in part on the filtered signal failing to satisfy the one or more thresholds.
Aspect 9: The method, apparatus, or non-transitory computer-readable medium of any of aspects 1 through 8, further including operations, features, circuitry, logic, means, or instructions, or any combination thereof for receiving, from the host device, a second request to perform a second equalization operation on a second signal; receiving the second signal from the host device via a second channel; performing the equalization operation on the second signal to obtain a filtered second signal; and transmitting, to the host device, an indication of one or more quality metrics for the filtered second signal.
Aspect 10: The method, apparatus, or non-transitory computer-readable medium of any of aspects 1 through 9, where receiving the signal further includes receiving the signal via a first channel, the first channel including a first subchannel configured for receiving signaling from the host device and a second subchannel configured for transmitting signaling to the host device and transmitting the indication of the one or more quality metrics further includes transmitting the indication of the one or more quality metrics via a second channel.
Aspect 11: The method, apparatus, or non-transitory computer-readable medium of any of aspects 1 through 10, where receiving the signal further includes receiving the signal via a first channel, the first channel including a first subchannel configured for receiving signaling from the host device and a second subchannel configured for transmitting signaling to the host device and transmitting the indication of the one or more quality metrics further includes transmitting the indication of the one or more quality metrics via the first channel.
Aspect 12: The method, apparatus, or non-transitory computer-readable medium of any of aspects 1 through 11, further including operations, features, circuitry, logic, means, or instructions, or any combination thereof for performing a mode change from a first mode to a second mode, the first mode corresponding to a first speed for communications, the second mode corresponding to a second speed for communications greater than the first speed, where the one or more filter parameters are for filtering communications at a third speed, the third speed greater than the second speed.
Aspect 13: The method, apparatus, or non-transitory computer-readable medium of aspect 12, where the indication of the one or more quality metrics is transmitted, to the host device, using the second speed for communications and the signal is received, from the host device, using the third speed for communications.
Aspect 14: The method, apparatus, or non-transitory computer-readable medium of any of aspects 12 through 13, where the request to perform the equalization operation is received, from the host device, using the second speed for communications.
Aspect 15: The method, apparatus, or non-transitory computer-readable medium of any of aspects 12 through 14, further including operations, features, circuitry, logic, means, or instructions, or any combination thereof for storing the one or more filter parameters in the memory device; performing a mode change from the second mode to a third mode, the third mode corresponding to the third speed for communications; receiving one or more signals from the host device; and filtering the one or more signals using the stored one or more filter parameters based at least in part on performing the mode change from the second mode to the third mode.
Aspect 16: The method, apparatus, or non-transitory computer-readable medium of any of aspects 12 through 15, further including operations, features, circuitry, logic, means, or instructions, or any combination thereof for refraining from performing the equalization operation for subsequent mode changes into a third mode based at least in part on storing the one or more filter parameters.
Aspect 17: The method, apparatus, or non-transitory computer-readable medium of any of aspects 1 through 16, further including operations, features, circuitry, logic, means, or instructions, or any combination thereof for transmitting, to the host device, an indication of one or more parameters for the host device based at least in part on the one or more quality metrics for the filtered signal failing to satisfy a threshold, the one or more parameters including a deemphasis parameter for signaling transmitted by the host device, a pre-emphasis parameter for signaling transmitted by the host device, a duty cycle correction parameter for signaling transmitted by the host device, an amplitude parameter for signaling transmitted by the host device, or any combination thereof.
Aspect 18: The method, apparatus, or non-transitory computer-readable medium of any of aspects 1 through 17, where performing the equalization operation further includes operations, features, circuitry, logic, means, or instructions, or any combination thereof for varying the one or more filter parameters for filtering the signal, where the varying is based at least in part on whether the one or more quality metrics for the filtered signal satisfy one or more thresholds.
Aspect 19: The method, apparatus, or non-transitory computer-readable medium of any of aspects 1 through 18, further including operations, features, circuitry, logic, means, or instructions, or any combination thereof for transmitting, to the host device, a request to perform a second equalization operation on a second signal, the second signal including a second pattern corresponding to the second equalization operation; transmitting, to the host device, the second signal; and receiving, from the host device, an indication of one or more quality metrics for the second signal, the one or more quality metrics based at least in part on the host device filtering the second signal.
Aspect 20: The method, apparatus, or non-transitory computer-readable medium of any of aspects 1 through 18, where one or more parameters for the signal are adjusted based at least in part on the one or more quality metrics for the filtered signal.

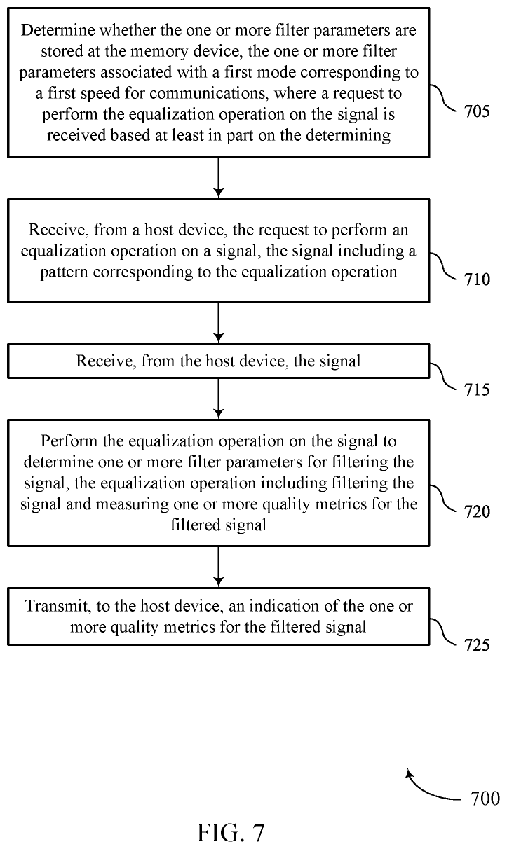

FIG. 7 illustrates a flowchart showing a method 700 that supports closed-loop equalization methods in accordance with examples as disclosed herein. The operations of method 700 may be implemented by a memory system or its components as described herein. For example, the operations of method 700 may be performed by a memory system as described with reference to FIGS. 1 through 4. In some examples, a memory system may execute a set of instructions to control the functional elements of the device to perform the described functions. Additionally, or alternatively, the memory system may perform aspects of the described functions using special-purpose hardware.

At 705, the method may include determining whether the one or more filter parameters are stored at the memory device, the one or more filter parameters associated with a first mode corresponding to a first speed for communications, where the request to perform the equalization operation on the signal is received based at least in part on the determining. The operations of 705 may be performed in accordance with examples as disclosed herein. In some examples, aspects of the operations of 705 may be performed by a determination component 440 as described with reference to FIG. 4.

At 710, the method may include receiving, from a host device, a request to perform an equalization operation on a signal, the signal including a pattern corresponding to the equalization operation. The operations of 710 may be performed in accordance with examples as disclosed herein. In some examples, aspects of the operations of 710 may be performed by a reception component 425 as described with reference to FIG. 4.

At 715, the method may include receiving, from the host device, the signal. The operations of 715 may be performed in accordance with examples as disclosed herein. In some examples, aspects of the operations of 715 may be performed by a reception component 425 as described with reference to FIG. 4.

At 720, the method may include performing the equalization operation on the signal to determine one or more filter parameters for filtering the signal, the equalization operation including filtering the signal and measuring one or more quality metrics for the filtered signal. The operations of 720 may be performed in accordance with examples as disclosed herein. In some examples, aspects of the operations of 720 may be performed by an equalization component 430 as described with reference to FIG. 4.

At 725, the method may include transmitting, to the host device, an indication of the one or more quality metrics for the filtered signal. The operations of 725 may be performed in accordance with examples as disclosed herein. In some examples, aspects of the operations of 725 may be performed by a transmission component 435 as described with reference to FIG. 4.

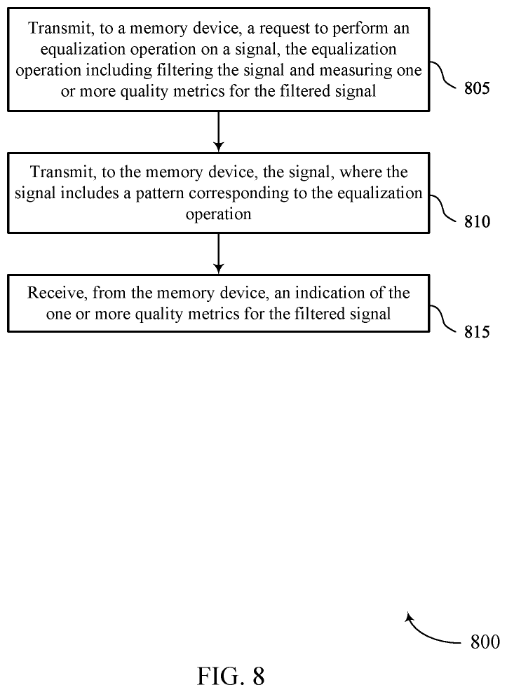

FIG. 8 illustrates a flowchart showing a method 800 that supports closed-loop equalization methods in accordance with examples as disclosed herein. The operations of method 800 may be implemented by a host system or its components as described herein. For example, the operations of method 800 may be performed by a host system as described with reference to FIGS. 1 through 3 and 5. In some examples, a host system may execute a set of instructions to control the functional elements of the device to perform the described functions. Additionally, or alternatively, the host system may perform aspects of the described functions using special-purpose hardware.

At 805, the method may include transmitting, to a memory device, a request to perform an equalization operation on a signal, the equalization operation including filtering the signal and measuring one or more quality metrics for the filtered signal. The operations of 805 may be performed in accordance with examples as disclosed herein. In some examples, aspects of the operations of 805 may be performed by a transmission manager 525 as described with reference to FIG. 5.

At 810, the method may include transmitting, to the memory device, the signal, where the signal includes a pattern corresponding to the equalization operation. The operations of 810 may be performed in accordance with examples as disclosed herein. In some examples, aspects of the operations of 810 may be performed by a transmission manager 525 as described with reference to FIG. 5.

At 815, the method may include receiving, from the memory device, an indication of the one or more quality metrics for the filtered signal. The operations of 815 may be performed in accordance with examples as disclosed herein. In some examples, aspects of the operations of 815 may be performed by a reception manager 530 as described with reference to FIG. 5.

In some examples, an apparatus as described herein may perform a method or methods, such as the method 800. The apparatus may include features, circuitry, logic, means, or instructions (e.g., a non-transitory computer-readable medium storing instructions executable by a processor), or any combination thereof for performing the following aspects of the present disclosure:
Aspect 21: A method, apparatus (e.g., a host system or host device, as described herein), or non-transitory computer-readable medium including operations, features, circuitry, logic, means, or instructions, or any combination thereof for transmitting, to a memory device, a request to perform an equalization operation on a signal, the equalization operation including filtering the signal and measuring one or more quality metrics for the filtered signal; transmitting, to the memory device, the signal, where the signal includes a pattern corresponding to the equalization operation; and receiving, from the memory device, an indication of the one or more quality metrics for the filtered signal.
Aspect 22: The method, apparatus, or non-transitory computer-readable medium of aspect 21, further including operations, features, circuitry, logic, means, or instructions, or any combination thereof for adjusting, at the host device, one or more parameters for the signal based at least in part on the one or more quality metrics for the filtered signal.
Aspect 23: The method, apparatus, or non-transitory computer-readable medium of aspect 22, where the one or more parameters include a deemphasis parameter, a pre-emphasis parameter, a duty cycle correction parameter, an amplitude parameter, or any combination thereof.
Aspect 24: The method, apparatus, or non-transitory computer-readable medium of any of aspects 21 through 23, further including operations, features, circuitry, logic, means, or instructions, or any combination thereof for transmitting, to the memory device, a second signal including the pattern, where one or more parameters for transmitting the second signal are based at least in part on the one or more quality metrics for the filtered signal.
Aspect 25: The method, apparatus, or non-transitory computer-readable medium of any of aspects 21 through 24, further including operations, features, circuitry, logic, means, or instructions, or any combination thereof for transmitting, to the memory device, a second signal including a second pattern, where one or more parameters for transmitting the second signal and the second pattern are based at least in part on the one or more quality metrics for the filtered signal.
Aspect 26: The method, apparatus, or non-transitory computer-readable medium of any of aspects 21 through 25, further including operations, features, circuitry, logic, means, or instructions, or any combination thereof for determining that the one or more quality metrics for the filtered signal fail to satisfy one or more thresholds for the one or more quality metrics and transmitting, to the memory device, a second signal based at least in part on the determination.
Aspect 27: The method, apparatus, or non-transitory computer-readable medium of aspect 26, further including operations, features, circuitry, logic, means, or instructions, or any combination thereof for receiving, from the memory device, an indication of one or more quality metrics for the second signal.
Aspect 28: The method, apparatus, or non-transitory computer-readable medium of any of aspects 21 through 27, further including operations, features, circuitry, logic, means, or instructions, or any combination thereof for transmitting, to the memory device, an indication that the equalization operation is complete for a first mode based at least in part on the one or more quality metrics for the filtered signal satisfying one or more thresholds for the one or more quality metrics.
Aspect 29: The method, apparatus, or non-transitory computer-readable medium of aspect 28, further including operations, features, circuitry, logic, means, or instructions, or any combination thereof for storing one or more parameters for transmitting signaling to the memory device based at least in part on transmitting the indication that the equalization operation is complete.
Aspect 30: The method, apparatus, or non-transitory computer-readable medium of any of aspects 21 through 29, further including operations, features, circuitry, logic, means, or instructions, or any combination thereof for transmitting, to the memory device, a request to perform a mode change from a first mode to a second mode, the first mode corresponding to a first speed for communications, the second mode corresponding to a second speed for communications greater than the first speed and performing the mode change from the first mode to the second mode based at least in part on transmitting the indication to perform the mode change.
Aspect 31: The method, apparatus, or non-transitory computer-readable medium of any of aspects 21 through 30, further including operations, features, circuitry, logic, means, or instructions, or any combination thereof for transmitting, to the memory device, a request to perform a second equalization operation on a second signal; transmitting the second signal to the memory device via a second channel; and receiving, from the memory device, an indication of one or more quality metrics for the second signal filtered by the memory device.
Aspect 32: The method, apparatus, or non-transitory computer-readable medium of any of aspects 21 through 31, where transmitting the signal further includes transmitting the signal via a first channel, the first channel including a first subchannel configured for transmitting signaling to the memory device and a second subchannel configured for receiving signaling from the memory device and receiving the indication of the one or more quality metrics further includes receiving the indication of the one or more quality metrics via a second channel.
Aspect 33: The method, apparatus, or non-transitory computer-readable medium of any of aspects 21 through 32, where transmitting the signal further includes transmitting the signal via a first channel, the first channel including a first subchannel configured for transmitting signaling to the memory device and a second subchannel configured for receiving signaling from the memory device and receiving the indication of the one or more quality metrics further includes receiving the indication of the one or more quality metrics via the first channel.
Aspect 34: The method, apparatus, or non-transitory computer-readable medium of any of aspects 21 through 33, further including operations, features, circuitry, logic, means, or instructions, or any combination thereof for performing a mode change from a first mode to a second mode, the first mode corresponding to a first speed for communications, the second mode corresponding to a second speed for communications greater than the first speed, where the equalization operation is for filtering signaling at a third speed, the third speed greater than the second speed.
Aspect 35: The method, apparatus, or non-transitory computer-readable medium of aspect 34, where the indication of the one or more quality metrics is received, from the memory device, using the second speed for communications and the signal is transmitted, to the memory device, using the third speed for communications.
Aspect 36: The method, apparatus, or non-transitory computer-readable medium of any of aspects 34 through 35, where the indication to perform the equalization operation is transmitted, to the memory device, using the second speed for communications.
Aspect 37: The method, apparatus, or non-transitory computer-readable medium of any of aspects 34 through 36, further including operations, features, circuitry, logic, means, or instructions, or any combination thereof for refraining from transmitting the indication to perform the equalization operation for subsequent mode changes into a third mode.
Aspect 38: The method, apparatus, or non-transitory computer-readable medium of any of aspects 21 through 37, further including operations, features, circuitry, logic, means, or instructions, or any combination thereof for receiving, from the memory device, an indication of one or more parameters for the host device, the one or more parameters including a deemphasis parameter for signaling transmitted by the host device, a pre-emphasis parameter for signaling transmitted by the host device, a duty cycle correction parameter for signaling transmitted by the host device, an amplitude parameter for signaling transmitted by the host device, or any combination thereof.
Aspect 39: The method, apparatus, or non-transitory computer-readable medium of any of aspects 21 through 38, further including operations, features, circuitry, logic, means, or instructions, or any combination thereof for receiving, from the memory device, a request to perform a second equalization operation on a second signal, the second signal including a second pattern corresponding to the second equalization operation; receiving, from the memory device, the second signal; performing the second equalization operation on the second signal to determine one or more filter parameters for filtering the second signal, the second equalization operation including filtering the second signal and measuring one or more second quality metrics for the filtered signal; and transmitting, to the memory device, an indication of the one or more second quality metrics for the filtered second signal.
Aspect 40: The method, apparatus, or non-transitory computer-readable medium of any of aspects 21 through 38, further including operations, features, circuitry, logic, means, or instructions, or any combination thereof for adjusting a setting associated with the equalization operation, the setting including one or more parameters for the signal, based at least in part on the one or more quality metrics for the filtered signal.

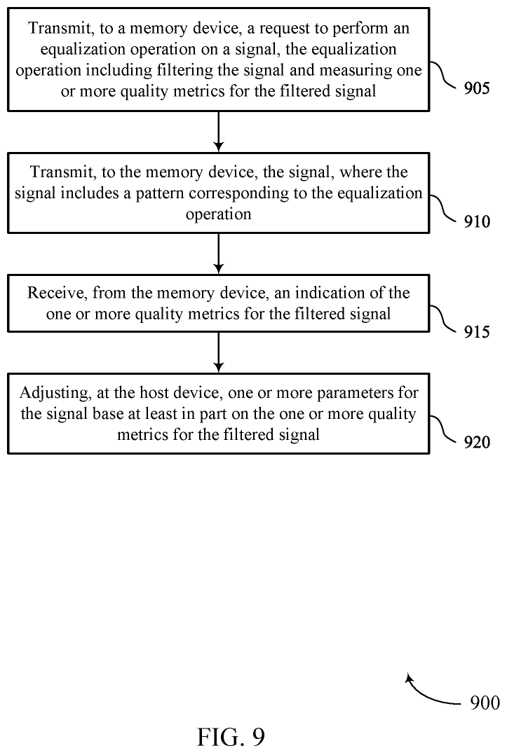

FIG. 9 illustrates a flowchart showing a method 900 that supports closed-loop equalization methods in accordance with examples as disclosed herein. The operations of method 900 may be implemented by a host system or its components as described herein. For example, the operations of method 900 may be performed by a host system as described with reference to FIGS. 1 through 3 and 5. In some examples, a host system may execute a set of instructions to control the functional elements of the device to perform the described functions. Additionally, or alternatively, the host system may perform aspects of the described functions using special-purpose hardware.

At 905, the method may include transmitting, to a memory device, a request to perform an equalization operation on a signal, the equalization operation including filtering the signal and measuring one or more quality metrics for the filtered signal. The operations of 905 may be performed in accordance with examples as disclosed herein. In some examples, aspects of the operations of 905 may be performed by a transmission manager 525 as described with reference to FIG. 5.

At 910, the method may include transmitting, to the memory device, the signal, where the signal includes a pattern corresponding to the equalization operation. The operations of 910 may be performed in accordance with examples as disclosed herein. In some examples, aspects of the operations of 910 may be performed by a transmission manager 525 as described with reference to FIG. 5.

At 915, the method may include receiving, from the memory device, an indication of the one or more quality metrics for the filtered signal. The operations of 915 may be performed in accordance with examples as disclosed herein. In some examples, aspects of the operations of 915 may be performed by a reception manager 530 as described with reference to FIG. 5.

At 920, the method may include adjusting, at the host device, one or more parameters for the signal based at least in part on the one or more quality metrics for the filtered signal. The operations of 920 may be performed in accordance with examples as disclosed herein. In some examples, aspects of the operations of 920 may be performed by a parameter manager 535 as described with reference to FIG. 5.

It should be noted that the described techniques include possible implementations, and that the operations and the steps may be rearranged or otherwise modified and that other implementations are possible. Further, portions from two or more of the methods may be combined.

Information and signals described herein may be represented using any of a variety of different technologies and techniques. For example, data, instructions, commands, information, signals, bits, or symbols of signaling that may be referenced throughout the above description may be represented by voltages, currents, electromagnetic waves, magnetic fields or particles, optical fields or particles, or any combination thereof. Some drawings may illustrate signals as a single signal; however, the signal may represent a bus of signals, where the bus may have a variety of bit widths.

The terms “electronic communication,” “conductive contact,” “connected,” and “coupled” may refer to a relationship between components that supports the flow of signals between the components. Components are considered in electronic communication with (or in conductive contact with or connected with or coupled with) one another if there is any conductive path between the components that can, at any time, support the flow of signals between the components. At any given time, the conductive path between components that are in electronic communication with each other (or in conductive contact with or connected with or coupled with) may be an open circuit or a closed circuit based on the operation of the device that includes the connected components. The conductive path between connected components may be a direct conductive path between the components or the conductive path between connected components may be an indirect conductive path that may include intermediate components, such as switches, transistors, or other components. In some examples, the flow of signals between the connected components may be interrupted for a time, for example, using one or more intermediate components such as switches or transistors.

The term “coupling” (e.g., “electrically coupling”) may refer to a condition of moving from an open-circuit relationship between components in which signals are not presently capable of being communicated between the components over a conductive path to a closed-circuit relationship between components in which signals are capable of being communicated between components over the conductive path. If a component, such as a controller, couples other components together, the component initiates a change that allows signals to flow between the other components over a conductive path that previously did not permit signals to flow.

The term “isolated” refers to a relationship between components in which signals are not presently capable of flowing between the components. Components are isolated from each other if there is an open circuit between them. For example, two components separated by a switch that is positioned between the components are isolated from each other if the switch is open. If a controller isolates two components, the controller affects a change that prevents signals from flowing between the components using a conductive path that previously permitted signals to flow.

The terms “if,” “when,” “based on,” or “based at least in part on” may be used interchangeably. In some examples, if the terms “if,” “when,” “based on,” or “based at least in part on” are used to describe a conditional action, a conditional process, or connection between portions of a process, the terms may be interchangeable.

The term “in response to” may refer to one condition or action occurring at least partially, if not fully, as a result of a previous condition or action. For example, a first condition or action may be performed and second condition or action may at least partially occur as a result of the previous condition or action occurring (whether directly after or after one or more other intermediate conditions or actions occurring after the first condition or action).

The devices discussed herein, including a memory array, may be formed on a semiconductor substrate, such as silicon, germanium, silicon-germanium alloy, gallium arsenide, gallium nitride, etc. In some examples, the substrate is a semiconductor wafer. In some other examples, the substrate may be a silicon-on-insulator (SOI) substrate, such as silicon-on-glass (SOG) or silicon-on-sapphire (SOP), or epitaxial layers of semiconductor materials on another substrate. The conductivity of the substrate, or sub-regions of the substrate, may be controlled through doping using various chemical species including, but not limited to, phosphorous, boron, or arsenic. Doping may be performed during the initial formation or growth of the substrate, by ion-implantation, or by any other doping means.

A switching component or a transistor discussed herein may represent a field-effect transistor (FET) and comprise a three terminal device including a source, drain, and gate. The terminals may be connected to other electronic elements through conductive materials, e.g., metals. The source and drain may be conductive and may comprise a heavily-doped, e.g., degenerate, semiconductor region. The source and drain may be separated by a lightly-doped semiconductor region or channel. If the channel is n-type (i.e., majority carriers are electrons), then the FET may be referred to as an n-type FET. If the channel is p-type (i.e., majority carriers are holes), then the FET may be referred to as a p-type FET. The channel may be capped by an insulating gate oxide. The channel conductivity may be controlled by applying a voltage to the gate. For example, applying a positive voltage or negative voltage to an n-type FET or a p-type FET, respectively, may result in the channel becoming conductive. A transistor may be “on” or “activated” if a voltage greater than or equal to the transistor's threshold voltage is applied to the transistor gate. The transistor may be “off” or “deactivated” if a voltage less than the transistor's threshold voltage is applied to the transistor gate.

The description set forth herein, in connection with the appended drawings, describes example configurations and does not represent all the examples that may be implemented or that are within the scope of the claims. The term “exemplary” used herein means “serving as an example, instance, or illustration” and not “preferred” or “advantageous over other examples.” The detailed description includes specific details to provide an understanding of the described techniques. These techniques, however, may be practiced without these specific details. In some instances, well-known structures and devices are shown in block diagram form to avoid obscuring the concepts of the described examples.

In the appended figures, similar components or features may have the same reference label. Further, various components of the same type may be distinguished by following the reference label by a hyphen and a second label that distinguishes among the similar components. If just the first reference label is used in the specification, the description is applicable to any one of the similar components having the same first reference label irrespective of the second reference label.

The functions described herein may be implemented in hardware, software executed by a processor, firmware, or any combination thereof. If implemented in software executed by a processor, the functions may be stored on or transmitted over, as one or more instructions or code, a computer-readable medium. Other examples and implementations are within the scope of the disclosure and appended claims. For example, due to the nature of software, the described functions can be implemented using software executed by a processor, hardware, firmware, hardwiring, or combinations of any of these. Features implementing functions may also be physically located at various positions, including being distributed such that portions of functions are implemented at different physical locations.

For example, the various illustrative blocks and components described in connection with the disclosure herein may be implemented or performed with a general-purpose processor, a DSP, an ASIC, an FPGA or other programmable logic device, discrete gate or transistor logic, discrete hardware components, or any combination thereof designed to perform the functions described herein. A general-purpose processor may be a microprocessor, but in the alternative, the processor may be any processor, controller, microcontroller, or state machine. A processor may be implemented as a combination of computing devices (e.g., a combination of a DSP and a microprocessor, multiple microprocessors, one or more microprocessors in conjunction with a DSP core, or any other such configuration).

As used herein, including in the claims, “or” as used in a list of items (for example, a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an exemplary step that is described as “based on condition A” may be based on both a condition A and a condition B without departing from the scope of the present disclosure. In other words, as used herein, the phrase “based on” shall be construed in the same manner as the phrase “based at least in part on.”

Computer-readable media includes both non-transitory computer storage media and communication media including any medium that facilitates transfer of a computer program from one place to another. A non-transitory storage medium may be any available medium that can be accessed by a general purpose or special purpose computer. By way of example, and not limitation, non-transitory computer-readable media can comprise RAM, ROM, electrically erasable programmable read-only memory (EEPROM), compact disk (CD) ROM or other optical disk storage, magnetic disk storage or other magnetic storage devices, or any other non-transitory medium that can be used to carry or store desired program code means in the form of instructions or data structures and that can be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, include CD, laser disc, optical disc, digital versatile disc (DVD), floppy disk, and Blu-ray disc, where disks usually reproduce data magnetically, while discs reproduce data optically with lasers. Combinations of these are also included within the scope of computer-readable media.

The description herein is provided to enable a person skilled in the art to make or use the disclosure. Various modifications to the disclosure will be apparent to those skilled in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A memory system, comprising:
one or more memory devices; and
processing circuitry coupled with the one or more memory devices and configured to cause the memory system to:
receive, from a host device, a request to perform an equalization operation on a signal, the signal comprising a pattern corresponding to the equalization operation;
receive, from the host device, the signal;
perform the equalization operation on the signal to determine one or more filter parameters for filtering the signal, the equalization operation comprising filtering the signal and measuring one or more quality metrics for the filtered signal; and
transmit, to the host device, an indication of the one or more quality metrics for the filtered signal.

2. The memory system of claim 1, wherein the processing circuitry is further configured to cause the memory system to:
determine whether the one or more filter parameters are stored at the one or more memory devices, the one or more filter parameters associated with a first mode corresponding to a first speed for communications, wherein the request to perform the equalization operation on the signal is received based at least in part on the determining.

3. The memory system of claim 1, wherein the processing circuitry is further configured to cause the memory system to:
receive, from the host device, a second signal comprising the pattern, wherein the second signal is based at least in part on the request of the one or more quality metrics for the filtered signal.

4. The memory system of claim 1, wherein the processing circuitry is further configured to cause the memory system to:
receive, from the host device, a second signal comprising a second pattern, wherein the second signal and the second pattern are based at least in part on the indication of the one or more quality metrics for the filtered signal.

5. The memory system of claim 1, wherein the processing circuitry is further configured to cause the memory system to:
receive, from the host device, a second signal, wherein the second signal is based at least in part on the indication of the one or more quality metrics for the filtered signal;
perform the equalization operation on the second signal to obtain a filtered second signal; and
transmit, to the host device, an indication of one or more quality metrics for the filtered second signal.

6. The memory system of claim 1, wherein the processing circuitry is further configured to cause the memory system to:
receive, from the host device, an indication that the equalization operation is complete based at least in part on the indication of the one or more quality metrics for the filtered signal.

7. The memory system of claim 6, wherein the processing circuitry is further configured to cause the memory system to:
store the one or more filter parameters in the one or more memory devices, wherein the storing is based at least in part on receiving, from the host device, the indication that the equalization operation is complete for a first mode;
perform a mode change from the first mode to a second mode;
perform a mode change from the second mode to the first mode; and
filter one or more signals using the stored one or more filter parameters based at least in part on performing the mode change from the second mode to the first mode.

8. The memory system of claim 1, wherein the processing circuitry is further configured to cause the memory system to:
determine that the one or more quality metrics for the filtered signal fail to satisfy one or more thresholds for the one or more quality metrics, wherein transmitting, to the host device, the indication of the one or more quality metrics for the filtered signal is based at least in part on the filtered signal failing to satisfy the one or more thresholds.

9. The memory system of claim 1, wherein the processing circuitry is further configured to cause the memory system to:
receive, from the host device, a second request to perform a second equalization operation on a second signal;
receive the second signal from the host device via a second channel;
perform the equalization operation on the second signal to obtain a filtered second signal; and
transmit, to the host device, an indication of one or more quality metrics for the filtered second signal.

10. The memory system of claim 1, wherein:
receiving the signal further comprises receiving the signal via a first channel, the first channel comprising a first subchannel configured for receiving signaling from the host device and a second subchannel configured for transmitting signaling to the host device; and
transmitting the indication of the one or more quality metrics further comprises transmitting the indication of the one or more quality metrics via a second channel.

11. The memory system of claim 1, wherein:
receiving the signal further comprises receiving the signal via a first channel, the first channel comprising a first subchannel configured for receiving signaling from the host device and a second subchannel configured for transmitting signaling to the host device; and
transmitting the indication of the one or more quality metrics further comprises transmitting the indication of the one or more quality metrics via the first channel.

12. The memory system of claim 1, wherein the processing circuitry is further configured to cause the memory system to:
perform a mode change from a first mode to a second mode, the first mode corresponding to a first speed for communications, the second mode corresponding to a second speed for communications greater than the first speed, wherein the one or more filter parameters are for filtering communications at a third speed, the third speed greater than the second speed.

13. The memory system of claim 12, wherein the indication of the one or more quality metrics is transmitted, to the host device, using the second speed for communications and the signal is received, from the host device, using the third speed for communications.

14. The memory system of claim 12, wherein the request to perform the equalization operation is received, from the host device, using the second speed for communications.

15. The memory system of claim 12, wherein the processing circuitry is further configured to cause the memory system to:
store the one or more filter parameters in the one or more memory devices;
perform a mode change from the second mode to a third mode, the third mode corresponding to the third speed for communications;
receive one or more signals from the host device; and
filter the one or more signals using the stored one or more filter parameters based at least in part on performing the mode change from the second mode to the third mode.

16. The memory system of claim 1, wherein the processing circuitry is further configured to cause the memory system to:
transmit, to the host device, an indication of one or more parameters for the host device based at least in part on the one or more quality metrics for the filtered signal failing to satisfy a threshold, the one or more parameters comprising a deemphasis parameter for signaling transmitted by the host device, a pre-emphasis parameter for signaling transmitted by the host device, a duty cycle correction parameter for signaling transmitted by the host device, an amplitude parameter for signaling transmitted by the host device, or any combination thereof.

17. The memory system of claim 1, wherein one or more parameters for the signal are adjusted based at least in part on the one or more quality metrics for the filtered signal.

18. A host device, comprising:
one or more controllers configured to couple with a memory system, wherein the one or more controllers are configured to cause the host device to:
transmit, to a memory system, a request to perform an equalization operation on a signal, the equalization operation comprising filtering the signal and measuring one or more quality metrics for the filtered signal;
transmit, to the memory system, the signal, wherein the signal comprises a pattern corresponding to the equalization operation; and
receive, from the memory system, an indication of the one or more quality metrics for the filtered signal.

19. The host device, of claim 18, wherein the one or more controllers are further configured to cause the host device:
adjust a setting associated with the equalization operation, the setting comprising one or more parameters for the signal, based at least in part on the one or more quality metrics for the filtered signal.

20. A non-transitory computer-readable medium storing code comprising instructions which, when executed by a processor of an electronic device, cause the electronic device to:
receive, from a host device, a request to perform an equalization operation on a signal, the signal comprising a pattern corresponding to the equalization operation;
receive, from the host device, the signal;
perform the equalization operation on the signal to determine one or more filter parameters for filtering the signal, the equalization operation comprising filtering the signal and measuring one or more quality metrics for the filtered signal; and
transmit, to the host device, an indication of the one or more quality metrics for the filtered signal.
